(19) United States
(12) Patent Application Publication
(10) Pub. No.: US 2003/0118501 A1
(43) Pub. Date: Jun. 26, 2003

(54) Surface treatment method for preparing water-resistant aluminum nitride powder

(75) Inventors: Shyan-Lung Chung, Yung-Kang City (TW); Chien-Ming Sung, Feng-Yuan City (TW); Chun-Hung Chen, Hsin-Ying City (TW); Ming-Tung Chou, Chang-Hua Hsien (TW); Hui-Chun Chen, Taipei City (TW); Cheng-Yu Hsieh, Taichung City (TW)

Correspondence Address: SUGHRUE-MION, PLLC, 2100 Pennsylvania Avenue, N.W., Washington, DC, 20037-3213, US

(73) Assignee: NATIONAL CHENG KUNG UNIVERSITY

(21) Appl. No.: 10/192,497

(22) Filed: Jul. 11, 2002

(30) Foreign Application Priority Data
Jul. 12, 2001 (TW) 090117060

(51) Int. Cl. C01B 21/072

(52) U.S. Cl. 423/412

(57) ABSTRACT

A surface treatment method for aluminum nitride includes the steps of:

obtaining an aluminum nitride powder; and

treating the aluminum nitride powder with a surface modifier by:

(a) simultaneously grinding and mixing the aluminum nitride powder with the surface modifier, or

(b) grinding the aluminum nitride powder and subsequently mixing the same with the surface modifier.

### CROSS-REFERENCE TO RELATED APPLICATION

This application claims priority of Taiwanese application No. 090117060, filed on Jul. 12, 2001.

### BACKGROUND OF THE INVENTION

1. Field of the Invention

The present invention relates to a surface treatment method for aluminum nitride, more particularly to a surface treatment method for aluminum nitride to obtain an aluminum nitride powder having superior moisture resistance.

2. Description of the Related Art

Aluminum nitride is a material superior in properties, such as heat conductivity, electrical insulation, thermal expansion, heat shock resistance, and corrosion resistance. Therefore, aluminum nitride is broadly used in various fields, such as electronic substrates, packing materials for integrated circuits, heat dissipators for electronic devices, heat conductive pastes, high heat conductive composite materials, and containers for receiving and processing molten salts or metals. However, since aluminum nitride is very sensitive to moisture, it is liable to absorb moisture in the atmosphere to form hydroxyl groups on the surface thereof, which can corrode electronic devices. The oxygen content in aluminum nitride is also increased thereby, which would lower heat conductivity. Therefore, there is a need to provide a modified aluminum nitride powder having superior moisture resistance.

Conventional methods for manufacturing aluminum nitride powder include the gas phase reaction method, the organometal precursor method, the reduction-nitridation method, the direct nitridation method, and the combustion synthesis method. The combustion synthesis method is a method for synthetizing ceramic materials by self-propagation combustion reaction. The details thereof are disclosed in U.S. Pat. Nos. 5,460,794, 5,453,407, and 5,649,278.

The key to the synthesis of an aluminum nitride powder via the combustion synthesis method resides in: (1) how to provide sufficient nitrogen, (2) how to prevent aluminum powder from molten aggregation, and (3) how to achieve a complete reaction. If nitrogen gas is used as a nitrogen source for the combustion synthesis reaction, the pressure for the reaction should be more than 1,000 atm. However, such a high pressure will increase cost, complexity and safety risks for equipment and operators. If liquid nitrogen is used as the nitrogen source for the reaction, it will suffer from the same drawbacks as gaseous nitrogen. A nitrogen-containing solid compound is used as a nitrogen source for the combustion synthesis reaction in U.S. Pat. No. 5,460,794 and U.S. Pat. No. 5,453,407. Although it is not necessary to use high pressure for the nitrogen-containing solid compound, the nitrogen-containing solid compound should be a thermal decomposable compound so as to conduct the reaction by self-propagation combustion. Specific design in reaction steps is required for decomposing the solid nitrogen-containing source to produce nitrogen useful for the reaction with an aluminum powder.

The method disclosed in U.S. Pat. No. 5,649,278 can prevent aluminum from molten aggregation, maintain flow of nitrogen, and obtain high conversion. However, limitations on the feed powder density will limit the selection of raw material. Furthermore, more than 30 wt % of inert diluent is required to homogeneously mix with aluminum and aluminum nitride. This will further increase cost and complexity, and lower productivity.

As described above, it is desirable to reduce the reactivity of aluminum nitride to moisture. The well-known methods for providing aluminum nitride with a moisture-proof effect include a solution coating method, a chemical surface treatment method, a surface oxidation treatment method, and a radio-frequency plasma chemical vapor deposition (CVD) method. Both the solution coating method and the radio-frequency plasma CVD apply a silica layer on the surface of aluminum nitride powder. There are two types of chemical surface treatment methods. One is to coat the surface of the aluminum nitride with a stearic acid, and the other is to use oleic acid for the surface treatment. The surface oxidation treatment method is uses an oxide layer to block aluminum nitride powder from moisture.

The solution coating method has drawbacks, such as difficulty in recovering hydrolysis catalysts, pollution problems, the requirement of high temperature oxidation process and high cost. Typically, there are two types of chemical surface treatment methods. One is the method described in Egashira et al. “Chemical Surface Treatments of Aluminum Nitride Powder Suppressing its Reactivity with Water,” J. Mater. Sci. Lett, 10, Pages 994-996 (1991). The other is the method described in Y. O. Li et al., “Surface Modification of Aluminum Nitride Powder,” J. Mater. Sci. Lett., 15, pages 1758-1761 (1996). In the aforesaid two methods, the solvent needs to be washed out several times, and removal of the residual surface modifier is time-consuming. In addition, it is difficult to recover the solvent. The radio-frequency plasma chemical vapor deposition (CVD) method requires expensive equipment. The surface oxidation treatment method may have drawbacks, such as extreme increase in oxygen amount and difficulty to control.

### SUMMARY OF THE INVENTION

Therefore, the object of the present invention is to provide a simplified and inexpensive method for surface treating aluminum nitride so as to obtain a modified aluminum nitride having superior moisture resistance.

The surface treatment method for aluminum nitride according to this invention comprises:

obtaining an aluminum nitride powder; and

treating the aluminum nitride powder with a surface modifier by:

(a) simultaneously grinding and mixing the aluminum nitride powder with the surface modifier, or

(b) grinding the aluminum nitride powder and subsequently mixing the same with the surface modifier.

### BRIEF DESCRIPTION OF THE DRAWING

Other features and advantages of the present invention will become apparent in the following detailed description of the preferred embodiments with reference to the accompanying drawing, of which:

FIG. 1 is a schematic view to illustrate the equipment to produce the crude aluminum nitride powder according to the process of this invention.

### DETAILED DESCRIPTION OF THIS INVENTION

The aluminum nitride powder used in this invention is commercial available from Starok, Denka Apio, Advanced Refractory Technologies (ART), Tokyo Aluminum K.K., etc., or is produced by synthesizing in an aluminum container.

The method for producing aluminum nitride powder by synthesizing in an aluminum container comprises the following steps:

Step (a) Preparation of an Aluminum Container:

The wall of the container may be perforated or non-perforated. The size of the container is determined on the basis of the amount of the reactant. The shape of the container is not critical, provided that the reactant can be received therein. The container with cylindrical, elliptical or spherical shape is preferred. The container may be provided with one or two openings, or may be sealed after placing the reactant within the container. When the container with two openings is used, the container can be disposed on a support before the reactant is placed therein. The support can be perforated or non-perforated, and can be manufactured from a material selected from following: graphite, AlN, Si₃N₄, Al₂O₃, ZrO₂, WC, etc.

Additionally, the aluminum container can be formed integrally, or can be made by a single layer or multiple layers of perforated or non-perforated aluminum foils. The wall thickness of the container is 0.01-0.5 mm, preferably 0.02-0.2 mm. The wall thickness is determined by the following conditions: (1) The aluminum container is provided with a mechanical strength sufficient for maintaining the shape of the container when the reactant is received therein; (2) When the combustion wave passes a certain section of the reactant, the wall of the aluminum container will undergo reaction and produce aluminum nitride powder. This enables nitrogen to react with the reactant in said section.

If the aluminum container is perforated, the diameter of the perforations ranges from 0.001 to 1.5 mm, preferably 0.02-1 mm. The perforation density (i.e. the ratio of the perforation area to the container wall area) is 1-50%, preferably 5-30%. The conditions that determine the size and the density of the perforations are as follows: (1) A sufficient amount of nitrogen has to flow to the reactant for complete reaction; (2) the perforated container must have a mechanical strength sufficient to maintain the shape thereof when the reactant is received therein; and (3) the reactant is not exposed. In order to produce the aluminum nitride powder with a high conversion rate, the aluminum content in the aluminum container used in the invention is preferably more than 25 wt %. The higher the aluminum content of the aluminum container, the higher will be the purity of the aluminum nitride. Conversely, if the aluminum content of the aluminum container is lower, a composite material consisting of aluminum nitride, impurities and nitrogen containing compound will be formed.

Step (b) Addition of Reactants to the Container:

The reactants comprise an aluminum containing powder or a mixture of aluminum containing powder with at least one of a diluent, additives and aluminum foil. The aluminum containing powder is selected from pure aluminum powder, aluminum alloy, a mixed powder of pure aluminum powder with other elements, or flakes of aluminum or aluminum alloy. The amount of aluminum in the aluminum containing powder is preferably more than 25 wt %. The higher the aluminum content, the higher will be the purity of the resulting aluminum nitride powder. The diluent is a powder having a high melting point but inert to reaction with the aluminum nitride powder. The inert diluent is selected from at least one of the following: AlN, BN, TiN, SiC, Si₃N₄, TiC, WC, Al₂O₃, ZrO₂, TiO₂, SiO₂, carbon powder, diamond powder, etc. It aluminum nitride is used as the diluent, the product is aluminum nitride. If the other materials are used as the diluent, the product is a composite material consisting of aluminum nitride and the diluent. The amount of the diluent is 0-80 wt % (preferably 1-50 wt %) based on the total weight of the reactant.

The additive used in this invention is selected from any one of the following compounds, or combinations thereof:

(i) ammonium halide, such as NH₄F, NH₄Cl, NH₄Br or NH₄I; and

(ii) a compound which contains NH, or halogen and which is decomposable or gasified at a temperature lower than the melting point of aluminum (660° C.). Examples of the compound include, but are not limited to, urea [CO (NR₂)₂], NH₂CO₂NH₄, ammonium carbonate [(NH₄)₂CO₃], NH₄HF₂, NH₄NO₃, NH₄HCO₃, HCOONH₄, N₂H₄·HBr, N₂H₄·2HCl·AlCl₃, AlBr₃, FeCl₃.

The amount of the additive is 0-80 wt % (preferably 1-50 wt %) based on the weight of the reactant. The purpose for adding the diluent, the additive and the aluminum foil in step (b) is to reduce the molten aggregation of the aluminum powder, and to facilitate nitrogen flow into the reactant so as to proceed with the reaction.

The aluminum foil used in this invention is in a form of non-densified flakes. The size of the aluminum foil ranges from 0.1 to 2 mm. The thickness of the aluminum foil ranges from 0.01 to 0.2 mm, preferably from 0.02 to 0.1 mm. The amount of aluminum in the aluminum foil is preferably more than 25 wt %. The amount of the aluminum foil is 0-30 wt % (preferably 0.1-10 wt %) based on the weight of the reactants.

Step (c) Addition of Aluminum Nitride Powder:

Aluminum nitride powder is placed between the reactant and the aluminum container, or a perforated aluminum tube is placed within the reactant. The thickness of the layer of aluminum nitride powder is 2-20 mm, preferably 3-10 mm. The aperture diameter of the aluminum nitride powder is 0.1-10 mm, preferably 1-5 mm. If perforated aluminum tube is used in this invention, the perforated aluminum tube may be an integrally formed tube having a plurality of pores in the tube wall. Alternatively, the perforated aluminum tube may be made by first forming an aluminum tube and then perforating the tube. The perforated aluminum tube may be formed by winding a layer or multiple layers of aluminum foil. The perforations of the aluminum tube can be formed before or after the winding. The height of the perforated aluminum tube is determined on a basis of the height of the reactant powder, when the perforated aluminum tube is installed, the bottom of the aluminum tube is disposed on the bottom of the aluminum container, and the top end of the aluminum tube protrudes from the top surface of the reactant powder. When the perforated aluminum tube is used for producing aluminum nitride powder in this invention, the inside diameter of the aluminum tube ranges from 1 mm to half of the inside diameter of the aluminum container, preferably from 2 to 5 mm. The thickness of the aluminum tube wall is 0.01-0.5 mm, preferably 0.05-0.2 mm. The tube wall thickness is determined by the condition that, when the surrounding reactant powder presses the aluminum tube until the aluminum tube can not ventilate, the reactant powder can be caused to combust completely so as to produce aluminum nitride. The diameter of the perforations in the tube wall is 0.001-1.5 mm, preferably 0.05-1 mm. The density of the perforations (the ratio of the total area of the perforations to the tube wall area) of the tube wall is 1-50% (preferably 5-30%). The number of the aluminum tubes used in the invention is not limited, provided that the total sectional area of the aluminum tube is 1-50% of the sectional area of the aluminum container.

The purpose of adding aluminum nitride powder is to further reduce the molten aggregation between the bottom of the aluminum container and the aluminum containing powder. The design of the perforated aluminum tube is to facilitate nitrogen flowing upward from the bottom toward the reactant.

Step (d) Adding the Initiator:

The initiator is disposed on the reactant. The initiator is an aluminum powder or a mixture formed by at least one of the materials selected from the group consisting of:

(i) the diluent used in step (b);

(ii) the additive used in step (b);

(iii) iodine; and

(iv) a mixture capable of high exothermal reaction, e.g., Ti+C, Al+Fe₃O₄, Al+Fe, Ni+Al, etc.

The amount of the material selected from the aforesaid group is 0.01-100 wt % (preferably 0.05-60 wt %) based on the weight of the initiator. The amount of the initiator is selected so that the thickness of the initiator after disposal on the top surface of the reactant is 1-30 mm preferably 2-20 mm). The purpose of adding the additive is to reduce the molten aggregation of aluminum powder on the top surface of the reactant, or to decrease the time for ignition, and to reduce the molten aggregation of aluminum containing powder.

Step (e) Forming a Nitrogen Atmosphere:

The aluminum container containing the reactant therein is disposed on a perforated bottom plate within a reactor made of ceramics of high melting point. The reactor is then purged with nitrogen through a pipe connected to the bottom of the reactor. The reactor is resistant to high pressure. The nitrogen pressure is regulated between 0.1 and 30 atms, preferably between 0.5 and 10 atms. The function of the perforated plate is to increase the rate of nitrogen entering into the reactor so as to increase the reaction rate.

Step (f) Combustion:

The aluminum powder is self-combusted via heating of a heating component disposed above the reactant and/or the initiator. The heating component is selected from tungsten filament, tungsten sheet, graphite, silicon carbide, barium silicide, chromel filament, and tantalum filament. Alternatively, the heating may be conducted via laser, infrared radiation or microwave. The top surface of the reactant should be heated to a temperature ranging from 700 to 1700° C. so as to conduct the self-combustion of aluminum powder.

Step (g) Synthesizing Aluminum Nitride Product:

The product from step (f) is cooled, and is then crushed to form a crude aluminum nitride powder.

The aluminum nitride powder so produced can be optionally washed with acid or heated at a temperature from 600 to 1400° C. under a nitrogen atmosphere so as to remove the residual aluminum.

The surface of the aluminum nitride powder so produced is treated with any one of the following chemical treatment processes:

(A) grinding the crude aluminum nitride powder, a surface modifier and a solvent capable of solving the surface modifier in a mill so as to result in a paste, separating the treated aluminum nitride powder from the paste, and drying the treated aluminum nitride powder;

(B) grinding the aluminum nitride powder, mixing the ground aluminum nitride powder with a surface modifier and a solvent capable of solving the surface modifier by stirring so as to result in a suspension, separating the treated aluminum nitride powder from the suspension, and drying the treated aluminum nitride powder; and

(C) grinding the aluminum nitride powder, blending the ground aluminum nitride powder with a surface modifier in a blender so as to result in flakes, and further grinding the flakes.

The surface modifier useful in this invention includes hydrophobic groups and is selected from the following:

(a) fatty acids of high carbon number: for example, stearic acid, oleic acid, etc;

(b) waxes: steatic acid wax, natural wax, etc.; and

(c) resins: for example, epoxy resin, polyurethane resin, silicone resin, polyester resin, phenolic resin, etc.

If the aforesaid chemical treatment process (A) is used, the surface modifier can be selected from fatty acids of high carbon number, waxes or resins. If the, aforesaid chemical treatment process (13) is used, the surface modifier can be selected from waxes or resins. If the aforesaid chemical treatment process (C) is used, resins are preferably used as the surface modifier. When resins are used for the surface modifier, a suitable amount of coupling agent can be added during the reaction so as to enhance the adhesivity of the surface of the aluminum nitride powder and to increase the interface strength between aluminum nitride powder and resins. In addition, a curing agent and an accelerator may be added to the resin-type surface modifier during the reaction so as to enhance the curing rate. Heating is also conducted during the blending step so as to partly cure the resin and to ensure that the aluminum nitride powder is coated with resin. The temperature for heating varies according to the surface modifier and curing agents. Generally, the heating temperature ranges from 80 to 200 C. For example, when o-cresol novolac epoxy resin is used as the surface modifier, phenol novolac is used as the curing agent, and Ph₃P is used as the accelerator, the heating temperature may range from 100 to 200° C., preferably from 120 to 180° C.

The solvent suitable for this invention is selected from methyl ethyl ketone, acetone, ethanol, ether, isopropanol, benzene, dimethyl formamide (DMF), or N,N-dimethyl acetamide (DMAC). The amount of the surface modifier varies according to the types of the solvent and the surface modifier. In the aforesaid chemical treatment process (A), the amount of the surface modifier is 2-50 wt % based on the total weight of the surface modifier and the solvent. In the aforesaid chemical treatment process (B), the amount of the surface modifier is 5-80 wt % based on the total weight of the surface modifier and the solvent.

The coupling agent useful in this invention is selected from vinyl triethoxy silane, amino propyl triethoxy silane, γ-glycidoxypropyl trimethoxy silane, or mercapto trimethoxy silane. The coupling agent (i.e., silane) is hydrolyzed to form a hydrolyzed coupling agent (i.e. silanetriol) by adding droplets of deionized water. The hydrolyzed coupling agent is then added into the aluminum nitride powder, and the aluminum nitride powder coated with the hydrolyzed coupling agent is blended with the surface modifier and the solvent. The coupling agent is applied via a direct adding method or a solution method. The amount of the coupling agent is 0.1-8.5 wt % relative to the aluminum nitride powder.

The curing agent useful in this invention is selected from amines, acid anhydrides, or phenols The accelerator useful in this invention is selected from amines, imidazoles, organophosphines, ureas, Lewis acids, or combinations thereof. The amount of the curing agent varies according to the types of the curing agent and the surface modifier, and is preferably 30-60 wt %. The amount of the accelerator varies according to the types of the curing agents, and is generally 0.1-1 wt %.

The mill useful in this invention is selected from an agitation type ball mill or a planetary type ball mill. The mill ball is a ceramic selected from aluminum oxide, zirconium oxide, aluminum nitride, silicon nitride, or tungsten carbide. The blender is selected from a single-screw extruder, a twin-screw extruder, or a roller mill. The drying method useful in this invention is selected from precipite separation drying, spray drying, vacuum drying, freeze drying, or fluidized bed filtration drying.

The aforesaid chemical treatment processes (A), (B) and (C) can be further classified into processes (A1)-(A4), (B1)-(B9) and (C1)-(C4), respectively, which are described in detail as follows:

(A1): Commercially available aluminum nitride powder, the surface modifier and the solvent capable of solving the surface modifier are mixed and agitated directly Then, the treated aluminum nitride powder is separated from the liquid phase, and dried so as to obtain the aluminum nitride having superior moisture resistance.

(A2): The aluminum nitride powder is coated with a coupling agent useful in this invention, and the coated aluminum nitride powder is mixed and agitated with the solvent and the surface modifier. Then, the treated aluminum nitride powder is separated from the liquid phase, and subsequently dried so as to obtain the modified aluminum nitride having superior moisture resistance. As described above, the coupling agent may be added by the direct adding method or the solution method.

(A3): The aluminum nitride powder, the solvent, the resin used as the surface modifier, the curing agent, and the accelerator are mixed, heating and agitated. Then, the treated aluminum nitride powder is separated from the liquid phase and dried so as to obtain the modified aluminum nitride having superior moisture resistance.

(A4): Same as (A3) except that the aluminum nitride powder is coated with a hydrolyzed coupling agent in advance.

(C1): The aluminum nitride powder is mixed with the resin surface modifier. The resulting mixture is blended in a mill so as to obtain a plate-like substance, which is then ground in a grinder to obtain the modified aluminum nitride having superior moisture resistance.

(C2): Substantially identical to (c1), except that the aluminum nitride powder is coated with a hydrolyzed coupling agent before blending.

(C3): Substantially identical to (C1), except that the curing agent and the accelerator are added in the blender for blending with the-mixture.

(C4): Substantially identical to (C2), except that the curing agent and the accelerator are added in the blender for blending with the mixture.

In processes (A1)-(A4), the grinding and anti-moisture treatments are conducted simultaneously, and the solvent is added during the grinding and anti-moisture treatments. Therefore, the treated aluminum nitride powder should be separated from the liquid phase, and then dried so as to obtain the inventive modified aluminum nitride having superior moisture resistance. Solvent is not used in processes (C1)-(C4). In the processes (C1)-(C4), aluminum nitride powder is blended with resin used as the surface modifier directly in a blender to form flakes, which are then ground. In the aforesaid processes, since the grinding and anti-moisture treatments are accomplished in one step, the processes are simplified and the cost thereof is accordingly reduced. Furthermore, since bonding between the ground aluminum nitride powder and the surface modifier is formed before the aluminum nitride powder comes into contact with air or moisture, the modified aluminum nitride powder so produced has superior anti-moisture property.

Aluminum nitride powder produced by synthesizing in an aluminum container is used in the aforesaid chemical treatment process (B). The chemical treatment process (B) can be further classified into the following:

(B1): The process is substantially identical to process (A1) except that the aluminum nitride powder produced by synthesizing in an aluminum container is used The aforesaid coarse-grain aluminum nitride powder, solvent and at least one surface modifier are mixed to form a mixture. The mixture is then ground and stirred in a grinder. The treated aluminum nitride powder is separated from the liquid phase, and then dried to produce the modified aluminum nitride powder having superior anti-moisture property.

(B2): The process is substantially identical to process (A1) except that the coarse-grain aluminum nitride powder produced by synthesizing in an aluminum container is used, The coarse-grain aluminum nitride powder is ground to have a specific particle size, and is then stirred with a solvent and a surface modifier, followed by separation and drying. The specific size of the aluminum nitride powder is determined depending on the subsequent processing. Any suitable grinding equipment known in the art can be used. The non-limiting examples of the grinding equipment include crusher, jaw crusher, chopper, ball mill and percussion grinder. The size of the ground aluminum nitride is generally 5-100 mm.

(B3): The process is substantially identical to process (A2) except that the coarse-grain aluminum nitride powder produced by synthesizing in an aluminum container is used.

The surface modifier used in the aforesaid processes (B1)-(B3) is not specifically limited and can be selected from any one of fatty acids of high carbon number, waxes and resins.

(B4): The process is substantially identical to process (B2) except that the curing agent and the accelerator are added into the reactant and that the reactant components are mixed under heat and stirring.

(B5): The process is substantially identical to process (B3) except that the curing agent and the accelerator are added into the reactant and that the reactant components are mixed under heat and stirring.

(B6): The process is similar to process (C1) except that the coarse-grain aluminum nitride powder produced by synthesizing in an aluminum container is ground to have a specific particle size and is then mixed with a resin serving as the surface modifier.

(B7): The process is identical to process (B6) except that the ground aluminum nitride powder is coated with a layer of coupling agent, and is then blended with the surface modifier.

(B8): The process is identical to process (B6) except that the curing agent and the accelerator are added into the reactant.

(B9): The process is identical to process (B7) except that the curing agent and the accelerator are added into the reactant.

Preparations:

Preparation of Crude Aluminum Nitride Powder by Synthesizing in an Aluminum Container

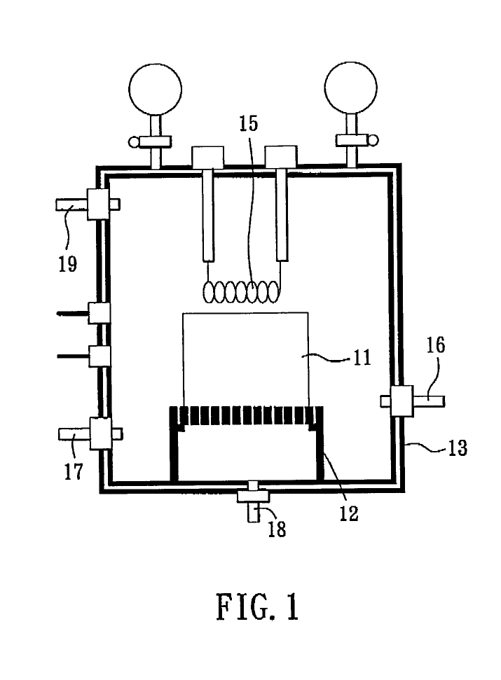

Aluminum foil sized 31.4 cm×16.2 cm×0.05 cm was wound around a cylindrical mold that is 50 mm in diameter and 20 mm in length to form an aluminum container having two open ends. Referring to FIG. 1, the aluminum container 11 was disposed on a perforated plate 12 made of graphite. Aluminum nitride powder having an average particle diameter of 1 mm was placed at the bottom of the aluminum container 11 to heap up to a height of 10 mm. 700 g of aluminum powder (average particle diameter: 40 μm) in flake shape was poured into the aluminum container. 259 of the same aluminum powder was mixed with 25 g of aluminum nitride powder to form a mixture that serves as the initiator which was then disposed on top of the aluminum powder. The height of the initiator was 5 mm.

The aluminum container 11 together with the perforated plate 12 was disposed within a pressure-resistant vacuum reactor 13. The reactor 13 was regulated so that the distance between the top of the initiator and tungsten-filament 15 was 4 mm. The reactor 13 was sealed, and was then vacuumed by vacuum pump 16 to a pressure of 0.1 torr. The reactor 13 was purged with nitrogen via valve 17 to a nitrogen pressure of about 1 atm. The vacuuming and purging processes were repeated three times so that the nitrogen pressure within the reactor 13 was 3 atm. The power (not shown) was turned on, and the heating efficiency was controlled at 1200 W. Nitrogen valve 18 installed under the bottom of the reactor 13 was opened so that nitrogen flowed into the reactor 13 via valve 18, passed through the reactant and flowed out of the initiator. The self-combustion occurred after a heating period of about 60 seconds. The power was then turned off. Nitrogen was supplied continuously via valve 18, and the flow rate of nitrogen was controlled at 50 l/sec. The pressure within the reactor 13 was maintained at 3 atm. The reaction time was about 10 mins.

During the reaction, the heat generated from tungsten-filament 15 was transmitted from the top surface of initiator toward the bottom of the aluminum container 11, and nitrogen flowed into the reactant through the bottom of the aluminum container 11 and the peripheral wall of the reactor 13. When the combustion wave generated by the tungsten-filament 15 advanced through the reactant within the aluminum container 11, the desired aluminum nitride product was left behind. The aluminum nitride product was cooled for about 10 mins after the reaction was completed. A release valve 19 was opened so as to reduce the pressure within the reactor 13 to 1 atm. The reactor 13 was then opened, and the aluminum nitride product was taken out of the reactor 13. The aluminum nitride product so produced was then ground using a planetary mill (rotation rate=400 rpm, grinding time=20 mins, the diameter of mill ball (zirconium oxide)=5 mm) to obtain an aluminum nitride powder having a particle diameter less than 10 μm. D₅₀ (determined by particle size analyzer) of the ground aluminum nitride powder was 5 μm. The ground aluminum nitride powder was analyzed by X-ray diffraction to show a strong characteristic peak of aluminum nitride. No characteristic peak of aluminum was observed. The conversion of the produced aluminum nitride powder was about 99.9%. The nitrogen content and the oxygen content were analyzed to be 33.2% and 0.8%, respectively. The surface area (determined by BET (Brunner-Emmett-Teller method) of the produced aluminum nitride powder was 2.3 m²/g.

500 g of the produced aluminum nitride powder and a steatic acid solution in acetone (molar ratio of stearic acid: acetone=1:1) were stirred for 3 hours in a beaker having a magnetic stirrer therein to obtain a suspension. The suspension was filtered via suctioning to obtain a powdery body, which was then dried in a vacuum drier at 85° C. so as to obtain the aluminum nitride powder product having anti-moisture property. The aluminum nitride powder product was placed in pure water at room temperature for 72 hours, and pH of the water was determined to be 8.52. If aluminum nitride powder without surface treatment is used for testing, pH of the water was found to be 10.06. An increased weight test was conducted for 50 hours in an environment having a temperature of 85° C. and a relative humidity of 85%. The increase in weight was 0.65 wt % . The powdery product was viewed using a transmission electron microscope to show a coating thereon. Therefore, it is demonstrated that the aluminum nitride powder product has anti-moisture property Instead of being ground by a planetary grinder, the crude aluminum nitride product may be crushed by a crusher to obtain the aluminum nitride powder having a particle diameter of 300 μm. Then, 500 g of the aluminum nitride powder so produced and 2.5 wt % of stearic acid solution in acetone were added into a stirred ball mill. The diameter of the mill ball is 5 mm. The weight of the Zirconium oxide mill ball was 1700 g. The grinding time was 40 mins. The grinding rate was 550 rpm. The aluminum nitride powder was filtered and dried as described above after grinding. The aforesaid analysis methods were conducted. D., was 10 μm. pH value was 8.2. The increased weight ratio of the powder was 0.6 wt %. A coating was formed on the powder. Therefore, it is demonstrated that the aluminum nitride powder product has anti-moisture property.

Preparations 1-3

Pure aluminum powders were used in the preparations. The aluminum container, reactant and nitrogen pressure used in the preparations are shown in Table 1.

TABLE 1

| | | Weight and | | Nitrogen | | |
|---|---|---|---|---|---|---|
| | | density of | | pressure | Conversion | |
| Prep. # | Aluminum container | reactant | | (atm) | (%) | Color |
| 1 | Perforated, dia. = | 50 | g | 2 | 91 | Gray, white |
| | 0.05-0.5 mm, | 0.55 | g/cm³ | | | |
| | perforation area = | | | | | |
| | 30% | | | | | |
| 2 | Perforated, dia. = | 100 | g | 3 | 92 | Gary, white |
| | 0.1-1 mm, | 0.55 | g/cm³ | | | |
| | perforation area = | | | | | |
| | 30% | | | | | |
| 3 | Non-perforated | 100 | g | 5 | 80 | Dark gray |
| | | 0.92 | g/cm³ | | | |
| 4 | Perforated, dia. = | 200 | g | 3 | 98.2 | Yelllowish |
| | 0.1-1 mm, | 0.55 | g/cm³ | | | Orange |
| | perforation area = | | | | | |
| | 30%, perforated | | | | | |
| | aluminum tube are | | | | | |
| | disposed therein | | | | | |
| 5 | Perforated, dia. = | 200 | g | 3 | 99 | Yellowish |
| | 0.1-1 mm, | 0.55 | g/cm³ | | | Orange |
| | perforation area = | | | | | |
| | 30%, aluminum | | | | | |
| | nitride powder layer | | | | | |
| | of 3 mm in thickness | | | | | |
| | is disposed between | | | | | |
| | reactant and | | | | | |
| | aluminum container | | | | | |
| | wall, perforated | | | | | |
| | aluminum tube are | | | | | |
| | disposed therein | | | | | |

The aluminum powder used in the preparations was in a form of flakes. Aperture D₅₀ was about 40 μm. Thickness was 0.1 μm. Purity was 99%. Oxygen amount was 0.5%. Aluminum container was formed in a cylindrical shape and provided with an opening. The container thickness was 0.0254 mm. The reactant was added into the aluminum container. Then, the aluminum container with the reactant therein was disposed within a high pressure-resistant vacuumed reactor, and was subsequently purged with nitrogen to the operating nitrogen pressure shown in Table 1. The top surface of the aluminum powder was heated by tungsten-filament till combustion. The heat-supplying power for the preparations was 1800 w. Ignition time was 60-100 sec. The reaction time was 3-6 min. The reaction time varies depending on the nitrogen pressure and/or the reactant density. The oxygen content of the product was 0.8-0.9 wt %. The combustion product was ground, and then analyzed by X-ray diffraction to show that the main component of the product is aluminum nitride.

Preparations 4 & 5:

Pure aluminum tube was used as the reactant. An aluminum nitride powder was disposed around the aluminum tube, or perforated aluminum tubes were disposed in the aluminum tube The operating conditions of Preparations 4 and 5 were substantially identical to those of Preparation 2. In Preparation 4, seven perforated aluminum tubes were disposed in the reactant. Each of the perforated aluminum tubes was 0.025 mm in wall thickness, 5 mm in diameter, 0.05-l mm in aperture diameter, and 50% in perforation area. The operating conditions of Preparation 5 were substantially identical to those of Preparation 4, except that a layer of aluminum nitride powder (thickness of 3 mm) was disposed between the reactant and the bottom wall of the container. The aperture diameter of the layer of aluminum nitride powder was 0.5-3 mm. The ground product was analyzed by X-ray diffraction to show that the main component in the product is aluminum nitride.

Preparation 6:

Pure aluminum powder was used as the reactant, and nitrogen was supplied from the bottom of the aluminum container. The aluminum container, the reaction conditions and the conversion for the preparation are shown in Table 2.

TABLE 2

| | | | Weight and | | The pressure and | | |
|---|---|---|---|---|---|---|---|
| | | Perforated | Density of | | flow rate of | | Conversion |
| Prep. # | Aluminum container | plate | reactant | | nitrogen | | (%) |
| 6 | perforated, | Inward | 800 | g, | 2 | atm | 99.5 |
| | thickness: 0.06 mm, | recessed | 0.53 | g/cm³ | 30 | l/min | |
| | Diameter: 10 cm, | | | | | | |
| | Height: 14 cm | | | | | | |

In this preparation, the power for heating was 2000 W. The ignition time was 60-100 sec. The reaction time was 10-15 mins. The color of the product after combustion was yellowish orange with a minor white at the periphery of the product. The product was analyzed by X-ray diffraction to show that the product is aluminum nitride powder. The oxygen content of the product was 0.7-0.8 wt %.

Preparations 7-8:

Pure aluminum powder added with a diluent was used as the reactant. The reactant, the operating conditions for the reaction, the properties of the product, and the conversion are shown in Table 3.

TABLE 3

| | | Weight and | | Pressure and | | | | |
|---|---|---|---|---|---|---|---|---|
| | | Density of | | flow rate of | | | Oxygen | Conversion |
| Prep.# | Reactant | reactant | | nitrogen | | Color | amount (%) | (%) |
| 7 | 50 wt% of | 700 | g | 2 | atm | White | 19.1 | 99.2 |
| | Al + 50 wt % of | 0.85 | g/cm³ | 80 | l/min | | | |
| | Al₂O₃ | | | | | | | |
| 8 | 70 wt % of Al + | 400 | g, | 3 | atm | Yellowish | 0.9 | 98.7 |
| | 30 wt % of | 0.75 | g/cm₃ | 0 | l/min | white | | |
| | aluminum | | | | | | | |
| | nitride | | | | | | | |

The aluminum container used in Preparation 7 was non-perforated, and the thickness thereof was 0.05 mm. Nitrogen was supplied from the bottom of the container. The perforated plate used in Preparation 7 was the same as that used in Preparation 6. The particle distribution of the diluent used in the preparation was as follows: aluminum nitride: 0.1-2 mm, Al₂O₃: 0.01-0.5 mm, SiC: D₅₀˜2 μm, Si₃N₄: D₅₀˜3 μm. Heat supplying power is 1200 W. Ignition time was 20-40 sec. The higher the diluent amount, the shorter will be the ignition time. The related operating conditions and the result of the reaction are shown in Table 3. The ground product was analyzed by X-ray diffraction to show that the product is aluminum nitride. No characteristic peak of aluminum was detected.

In Preparation 8, a layer of aluminum nitride was disposed around the reactant, and perforated aluminum tubes were disposed in the reactant. The characteristics of the aluminum nitride layer and the perforated aluminum tube are the same as those in Preparation 5. The other operating conditions and the result are shown in Table 3. The ground product is shown to be aluminum nitride, and the color thereof is yellowish white. If neither the perforated aluminum tube nor the aluminum nitride layer is used in Preparation 8, the color of the product is gray white or light brown. The conversion of the product decreases (about 95%).

Preparations 9-10:

Pure aluminum powder added with additives is used as reactant. The other reactants and the operating conditions are shown in Table 4.

TABLE 4

| | Reactant composition | Weight and Density | | Pressure and flow | | Conversion |
|---|---|---|---|---|---|---|
| Prep. # | (wt %) | of reactant | | rate of nitrogen | | (%) |
| 9 | 99.5 wt % of aluminum + | 600 | g, | 2 | atm | 99.5 |
| | 0.5 wt % of NH₄Cl | 0.63 | g/cm³ | 50 | l/min | |
| 10 | 99.5 wt % of aluminum + | 500 | g, | 3 | atm | 98.9 |
| | 0.5 wt % of NH₄Cl | 0.6 | g/cm³ | 0 | l/min | |

The operating conditions used in Preparation 9 were identical to those used in Preparation 6. The operating conditions different from those used in Preparation 6 and the result of Preparation 9 are shown in Table 4. The power for heating was 1200 W. Ignition time was 10-20 sec. Reaction time was 5-10 min. The product after combustion is yellowish brown. The ground product was analyzed by X-ray diffraction to show that the product is aluminum nitride. No characteristic peak of aluminum was detected.

The operating conditions used in Preparation 10 were substantially identical to those used in Preparation 4. The operating conditions for Preparation 10 different from those for Preparation 4 and the result of Preparation 10 are shown in Table 4. The morphology and the color of the product in Preparation 10 are identical to those in Preparation 9. When neither aluminum nitride layer nor perforated aluminum tube is used in Preparation 10, the product contains non-reacted aluminum via the X-ray diffraction analysis The conversions are 96.2% and 95.0, respectively.

Preparations 11-12:

Pure aluminum powder was used as the reactant. Initiator was also used in the preparation. The other operating conditions and the result are shown in Table 5.

TABLE 5

| | | Thickness | Weight and | | Pressure and | | Oxygen | |
|---|---|---|---|---|---|---|---|---|
| | Initiator | of | density of | | flow rate of | | amount | Conversion |
| Prep. # | composition | initiator | reactant | | nitrogen | | (wt %) | (%) |
| 11 | 99 wt % of Al + 1 | 3 mm | 500 | g | 3 | atm | 0.67 | 99.4 |
| | wt % of NH₁Cl | | 0.6 | g/cm³ | 60 | l/min | | |
| 12 | 50 wt % of Al + | 5 mm | 750 | g | 3 | atm | 0.53 | 99.9 |
| | 50 wt % of | | 0.53 | g/cm³ | 50 | l/min | | |
| | aluminum | | | | | | | |
| | nitride | | | | | | | |

The aluminum powder used in Preparation 11 was 99 wt % in purity, and the oxygen content thereof was 0.5 wt %. The aluminum powder used in Preparation 12 was 99.7 wt % in purity, and the oxygen content thereof was 0.1 wt %. The power for heating was 1200 W. Ignition time was 10-20 sec. The color of the combustion product is yellowish brown. The ground product is aluminum nitride via X-ray diffraction analysis.

### EXAMPLES

### Examples 1-4:

Grinding and surface treatment of powder were conducted simultaneously in the examples. Aluminum nitride sources, surface modifiers and solvents used in the examples were different. The aluminum nitride powders used in the examples come from two sources, one being commercially available aluminum nitride powder, and the other being the aluminum nitride powder prepared as hereinbefore described. The aluminum nitride powder prepared as hereinbefore described was ground such that the diameter D₅₀ of the aluminum nitride powder was 20 μm. The commercially available aluminum nitride powder was obtained from Advanced Refractory Technologies (ART) (Grade #=A500-FX150), and the D₅₀ thereof was also 20 μm.

Aluminum nitride powder and 170 g of grinding medium formed of the surface modifier and the solvent shown in Table 6 were added to a stirred ball mill. The ball mill contained 1700 g of zirconium oxide (diameter=1 mm) as mill balls for grinding. Grinding was conducted by the ball mill at 550 rpm for 40 min to form a paste. The paste was evaporated under reduced pressure, and then dried to obtain a powdery product, which was analyzed using a particle size analyzer to show D₅₀=1.2 μm. The moisture resistance of the product was measured by the hydrolysis test described hereinbefore. The aluminum nitride source, the surface modifier and the solvent used in the examples and the moisture resistance of the products obtained in the examples are shown in Table 6:

TABLE 6

| | | | | PH value (25° C., |
|---|---|---|---|---|
| | Aluminum nitride | Surface modifier | | after 72 hour |
| Ex. # | source | (wt %) | Solvent | hydrolysis) |
| 1 | Prep. 4 | Stearic acid | Acetone | 8.21 |
| | | (5 wt %) | | |
| 2 | ART | Natural wax | Ethanol | 8.3 |
| | | (3.5 wt %) | | |
| 3 | Prep. 6 | O-cresol novolac epoxy | Methyl ethyl | 8.2 |
| | | (6 wt %) | ketone | |
| 4 | ART | Stearic acid | Benzene | 8.1 |
| | | (5 wt %) | | |

Examples 1-6:

The surface treatment of aluminum nitride powder was conducted via a solution method. The aluminum nitride powder source, the surface modifier and the solvent used in the examples are shown in Table 7. The aluminum nitride powder sources used in the examples were either commercially available or prepared as described hereinbefore. D₅₀ was 1.2 μm for the aluminum nitride powder prepared as described hereinbefore. D₅₀ was 1.6 μm for the commercially available aluminum nitride powder (Grade #. A-100). 75 g of aluminum nitride powder and a solution formed of the surface modifier and the solvent were stirred in a beaker having a magnetic stirrer therein for 3 hours to obtain a suspension. The suspension was filtrated by suction filter to obtain a treated aluminum nitride powder, which was then dried under vacuum at 150° C. for 3 hours to obtain the surface treated aluminum nitride powder product.

The moisture resistance of the product was measured by the hydrolysis analysis described hereinbefore. The result is shown in Table 7:

TABLE 7

| | Aluminum | | | pH (80° C., |
|---|---|---|---|---|
| | Nitride | | | after 20 hour |
| Ex. # | Source | Surface Modifier | Solvent | hydrolysis) |
| 5 | Prep. 1 | Stearic acid wax | Acetone | 7.8 |
| | | (10%) | | |
| 6 | ART | O-cresol novolac | Methyl ethyl | 8.5 |
| | | epoxy (10 wt %) | ketone | |

### Example 7:

Aluminum nitride powder synthesized in Preparation 3 was mixed under stirring with hydrolyzed silane, dried, and then further mixed under stirring with a surface modifier solution formed of a resin, a curing agent and an accelerator in a beaker for 3 hours to form a suspension. The suspension was filtrated by suction filer to obtain a treated aluminum nitride powder, which was then dried in a vacuum oven at 180° C. for 3 hours so as to cure the resin coated on the treated aluminum nitride powder. The result of the example is shown in Table 8.

TABLE 8

| | Aluminum | | | pH (80° C., |
|---|---|---|---|---|
| | nitride | | | after 20 hour |
| Ex. # | source | Surface modifier (wt %) | Solvent | hydrolysis) |
| 7 | Prep. 3 | O-cresol novolac epoxy (4 | Acetone | 8.3 |
| | | wt %) + Phenol novolac (2.1 | | |
| | | wt %) + Ph₃P (0.045 wt %) | | |

### Example 8:

The procedure in Example 7 was repeated except that the treated aluminum nitride powder was dried in a vacuum oven at 80° C. for 1 hour so as to partially cure the resin coated on the treated aluminum nitride powder. When the treated aluminum nitride powder is mixed with other polymer material to produce a composite material, since the treated aluminum nitride powder still contains unreacted functionality, it can form a bonding with the polymer.

### Examples 9-10

The surface treatment of aluminum nitride powder was conducted by coating the powder with a silane coating, followed by a treatment via a solution method. The aluminum nitride powder used in the examples was either commercially available aluminum nitride powder or aluminum nitride powder produced as described hereinbefore. D₅₀ was 1.2 μm for the aluminum nitride powder as produced. D₅₀ was 1.6 μm for the commercially available aluminum nitride powder (Grade: A-100). The procedure in Example 7 was repeated except that the aluminum nitride powder was coated with hydrolysized silane, before the moisture resistance treatment. The aluminum nitride sources, curing agents, coating methods, and the moisture resistance of the examples are shown in Table 9. The result shows that water-resistance increases when the aluminum nitride powder is coated with the coupling agent before the surface treatment.

TABLE 9

| | | | | pH (25° C., after |
|---|---|---|---|---|
| | Aluminum nitride | Coupling agent | | 72 hour |
| Ex. # | source | (wt %) | Coating method | hydrolysis) |
| 9 | Prep. 7 | γ-glycidoxypropyl | Direct addition | 8.1 |
| | | trimethoxy silane (2 | | |
| | | wt %) | | |
| 10 | ART | γ-amino propyl | Solution | 8.03 |
| | | triethoxy silane | | |

### Examples 11-13

The surface treatment in the examples was conducted by milling. The aluminum nitride powder sources used in the examples were either commercially available or prepared as described above. D., was 7.2 gm for the aluminum nitride powder as prepared above. D₅₀ was 10 μm for the commercially available aluminum nitride powder (Grade #. A 500-FX50). In the examples, 100 g of aluminum nitride powder was mixed with the surface modifier in a mixer for 1 hour to form a mixture. The mixture was milled in a roller-type mill at 120° C. The milling was repeated till a homogeneous mixture was obtained. The sheet product from the mill was crushed by a crusher, and then ground into powder by a grinder. The aluminum nitride sources, the surface modifier, and the moisture resistance of the examples are shown in Table 10.

TABLE 10

| | Aluminum | | PH (80° C., |
|---|---|---|---|
| | nitride | Surface modifier | after 20 hour |
| Ex. # | source | (wt %) | hydrolysis) |
| 11 | Prep. 9 | Bisphenol A epoxy (6 wt %) | 8.55 |
| 12 | ART | Bisphenol A epoxy (5 wt %) + phthalic | 8.2 |
| | | anhydride (2 wt %) + Ph₃P (0.4 wt %) | |
| 13 | Prep. 10 | O-cresol novolac epoxy (25 wt %) | 8.34 |

### Examples 14-15:

The procedure in Example 12 was repeated except that the aluminum nitride powder was first coated with a layer of coupling agent. The aluminum nitride source, curing agent, coating method and moisture resistance of the examples are shown in Table 11.

TABLE 11

| | Aluminum | | | pH (25° C., |
|---|---|---|---|---|
| | nitride | Coupling Agent | Coating | after 72 hour |
| Ex. # | source | (wt %) | method | hydrolysis) |
| 14 | Prep. 11 | Mercapto-trimethoxy | Solution | 7.9 |
| | | silane (0.5 wt %) | | |
| 15 | ART | amino propyl | Direct | 7.83 |
| | | triethoxy | Addition | |
| | | silane (1.5 wt %) | | |

In view of the aforesaid, in the inventive method for manufacturing aluminum nitride powder having a moisture resistance and a specific particle size distribution, the surface treatment can be conducted after grinding or simultaneously with grinding. In the method where the surface treatment is conducted simultaneously with grinding, it is merely necessary to simultaneously add the surface modifier and the grinding solvent into a grinder before wet-grinding the aluminum nitride powder. Therefore, the inventive method is convenient in operation. Furthermore, during grinding, fresh aluminum nitride particles are produced continuously. The surface modifier coats the surface of the aluminum nitride powder via chemical bonding between the surface modifier and the aluminum nitride powder so as to achieve the moisture resistance property. Additionally, the aluminum nitride powder having specific particle distribution can be obtained during the grinding. As compared to the prior art described above, the present invention overcomes the drawbacks such as long treatment time, expensive equipment, and difficulty to control the treatment process. Furthermore, as compared to U.S. Pat. No. 5,234,712, in addition to lower costs, the present invention overcomes the drawbacks such as requirement of high temperature oxygenation, pollution and difficulty in catalyst recovery.

Additionally, the crude aluminum nitride powder is produced directly in an aluminum container, rather than in a refractory container. It is not required to press the reactant into pellets during manufacturing. Therefore, the method used in the invention for manufacturing the crude aluminum nitride powder provides the advantages such as relatively high conversion, reduced cost and reduced pollution.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

We claim:

1. A process for producing water-resistant aluminum nitride powder, comprising:
obtaining an aluminum nitride powder; and
treating the aluminum nitride powder with a surface modifier by:
(a) simultaneously grinding and mixing the aluminum nitride powder with the surface modifier, or
(b) grinding the aluminum nitride powder and subsequently mixing the same with the surface modifier.

2. The process as claimed in claim 1, wherein, in step (a), the aluminum nitride powder is simultaneously ground and mixed with the surface modifier in a ball mill which includes a grinding medium.

3. The process as claimed in claim 2, wherein, in step (b), the aluminum nitride powder is mixed with the surface modifier in an extruder or a roll mill, following by the grinding of the product exiting from the extruder or the roll mill.

4. The process as claimed in claim 1, wherein the surface modifier includes at least one compound selected from the group consisting of a fatty acid of high carbon number, a wax, and resin.

5. The process as claimed in claim 4, wherein said fatty acid of high carbon number is selected from the group consisting of stearic acid and oleic acid, said wax is selected from the group consisting of steatic acid wax and natural wax, and said resin is selected from the group consisting of epoxy resin, polyurethane resin, silicone resin, polyester resin, and phenolic resin.

6. The process as claimed in claim 4, wherein the surface modifier further includes a solvent selected from the group consisting of methyl ethyl ketone, acetone, ethanol, ether, isopropanol, benzene, dimethyl formamide, and N,N-dimethyl acetamide.

7. The process as claimed in claim 6, further comprising the step of separating the aluminum nitride powder from the solvent, and drying the aluminum nitride powder after separation.

8. The process as claimed in claim 2, wherein the grinding medium is made of a material selected from the group consisting of zirconium oxide, aluminum oxide, aluminum nitride, silicon nitride, and tungsten carbide.

9. The process as claimed in claim 4, wherein the surface modifier includes a resin, and further includes a curing agent selected from the group consisting of amines, acid anhydrides, and phenols.

10. The process as claimed in claim 4, wherein the surface modifier includes a resin, and further includes an accelerator selected from the group consisting of amines, imidazoles, organophosphines, ureas, Lewis acids, and a combination thereof.

11. The process as claimed in claim 9, wherein the aluminum nitride powder is treated with a coupling agent before being mixed with the resin and the curing agent, the coupling agent being selected from the group consisting of vinyl triethoxy silane, amino propyl triethoxy silane, γ-glycidoxypropyl trimethoxy silane, and mercapto trimethoxy silane.

12. The process as claimed in claim 1, wherein the aluminum nitride powder is prepared via a combustion synthesis which comprises;
preparing an aluminum container;
placing a particulate aluminum into said aluminum container; and
heating said aluminum container and said particulate aluminum in a nitrogen atmosphere to proceed with a self-propagating combustion;
wherein said aluminum container undergoes a reaction with nitrogen.

13. The process as claimed in claim 12, wherein said aluminum container has a container wall with a wall thickness of about 0.01-0.5 mm.

14. The process as claimed in claim 13, wherein said container wall is provided with perforations.

15. The process as claimed in claim 14, wherein said perforations have a pore diameter of about 0.001-1.5 mm.

16. The process as claimed in claim 15, wherein the total area of the perforations is 1-50% of the total area of the container wall.

17. The process as claimed in claim 12, wherein nitrogen is caused to pass through the aluminum container from a bottom end to a top end of the aluminum container.

18. The process as claimed in claim 17, wherein an aluminum nitride powder is added to the aluminum container as a diluent, the diluent being placed between the particulate aluminum and said container wall of the aluminum container.

19. A process for producing an aluminum nitride powder via a combustion synthesis which comprises:
preparing an aluminum container;
placing a particulate aluminum into said aluminum container; and
heating said aluminum container and said particulate aluminum in a nitrogen atmosphere to proceed with a self-propagating combustion, wherein said aluminum container undergoes a reaction with nitrogen.

20. The process as claimed in claim 19, wherein said aluminum container has a container wall with a wall thickness of about 0.01-0.5 mm.
